(19) United States
(12) Patent Application Publication
(10) Pub. No.: US 2025/0070555 A1
(43) Pub. Date: Feb. 27, 2025

(54) POWER CONVERSION DEVICE, RECORDING MEDIUM, AND CONTROL METHOD

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Yukina AKIYAMA, Kawasaki Kanagawa (JP); Shunsuke KAWACHI, Tama Tokyo (JP); Yuki KUDO, Fuchu Tokyo (JP); Yoko SAKAUCHI, Fuchu Tokyo (JP); Koji TOBA, Tama Tokyo (JP); Kenji MITSUMOTO, Setagaya Tokyo (JP); Daisuke TAKEDA, Kawasaki Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/726,443

(22) PCT Filed: Jan. 7, 2022
(86) PCT No.: PCT/JP2022/000392

§ 371 Date: Jul. 3, 2024

(51) Int. Cl. H02J 3/18; H02M 7/48

(52) U.S. Cl. CPC H02J 3/1835; H02M 7/48

(57) ABSTRACT

A power conversion device includes a conversion circuit, a grid forming control circuit, a grid following control circuit, a modulation circuit, a switching circuit, a phase synchronization processing circuit, an initial value computing circuit, and a synchronization adjusting circuit. When a switching signal instructing switching from grid forming control to grid following control is received, the phase synchronization processing circuit computes a synchronous phase by phase synchronization processing for which an amplitude of a grid voltage is used as input. The initial value computing circuit computes an initial amplitude command value based on the amplitude of the grid voltage and the synchronous phase. The synchronization adjusting circuit sets the initial amplitude command value to be an initial value of a command value of an amplitude of an output voltage in the grid following control after switching from the grid forming control.

### CROSS-REFERENCE TO RELATED APPLICATIONS

This application is national stage application of International Application No. PCT/JP2022/000392, filed on Jan. 7, 2022, which designates the United States, incorporated herein by reference.

### FIELD

Embodiments described herein relate generally to a power conversion device, a recording medium, and a control method.

### BACKGROUND

In recent years, utilization of an inverter power supply is developed. The inverter power supply converts DC power output from power supplies such as generators utilizing renewable energy and storage batteries into AC power and outputs the AC power. As a control system for inverter power supplies, a grid forming (GFM) type and a grid following (GFL) type have been known. Control of the GFM type (hereinafter referred to as GFM control) is control for maintaining an amplitude and a phase of an output voltage of an inverter power supply at given set values. Control of the GFL type (hereinafter referred to as GFL control) is control for causing the amplitude and the phase of the output voltage of the inverter power supply to follow an amplitude and a phase of a voltage of a given power grid. The GFM control and the GFL control described above may be switched in accordance with use situations and the like of the inverter power supply.

### BACKGROUND

In recent years, utilization of an inverter power supply is developed. The inverter power supply converts DC power output from power supplies such as generators utilizing renewable energy and storage batteries into AC power and outputs the AC power. As a control system for inverter power supplies, a grid forming (GFM) type and a grid following (GFL) type have been known. Control of the GFM type (hereinafter referred to as GFM control) is control for maintaining an amplitude and a phase of an output voltage of an inverter power supply at given set values. Control of the GFL type (hereinafter referred to as GFL control) is control for causing the amplitude and the phase of the output voltage of the inverter power supply to follow an amplitude and a phase of a voltage of a given power grid. The GFM control and the GFL control described above may be switched in accordance with use situations and the like of the inverter power supply.

### BRIEF DESCRIPTION OF DRAWINGS

FIG. 1 is a block diagram of an example of a configuration of a power system of an embodiment;

FIG. 2 is a block diagram of an example of a hardware configuration of a power conversion device of the embodiment;

FIG. 3 is a block diagram of an example of a functional configuration of the power conversion device of the embodiment;

FIG. 4 is a control block diagram of a first example of processing in a GFL controller of the embodiment;

FIG. 5 is a control block diagram of a second example of the processing in the GFL controller of the embodiment; and

FIG. 6 is a flowchart of an example of processing at the time of switching from GFM control to GFL control by the power conversion device of the embodiment.

### DETAILED DESCRIPTION

A power conversion device of an embodiment includes a conversion circuit, a grid forming control circuit, a grid following control circuit, a modulation circuit, a switching circuit, a phase synchronization processing circuit, an initial value computing circuit, and a synchronization adjusting circuit. The conversion circuit is configured to convert DC power output from a power supply into AC power and output the AC power. The grid forming control circuit is configured to generate a first modulation command to change an amplitude and a phase of an output voltage from the conversion circuit by grid forming control for maintaining the amplitude and the phase of the output voltage at given set values. The grid following control circuit is configured to generate a second modulation command to change the amplitude and the phase of the output voltage by grid following control for causing the amplitude and the phase of the output voltage to follow an amplitude and a phase of a grid voltage as a voltage of a given power grid. The modulation circuit is configured to change the amplitude and the phase of the output voltage on the basis of the first modulation command or the second modulation command. The switching circuit is configured to switch, in accordance with a switching signal, input to the modulation circuit such that either the first modulation command or the second modulation command is input to the modulation circuit. The phase synchronization processing circuit is configured to compute a synchronous phase by phase synchronization processing for which the amplitude of the grid voltage is used as input. The synchronous phase is computed when the switching signal instructing switching from the grid forming control to the grid following control is received. The initial value computing circuit is configured to compute an initial amplitude command value based on the amplitude of the grid voltage and the synchronous phase. The synchronization adjusting circuit is configured to set the initial amplitude command value to be an initial value of a command value of the amplitude of the output voltage in the grid following control after switching from the grid forming control.

The following describes an embodiment with reference to the accompanying drawings.

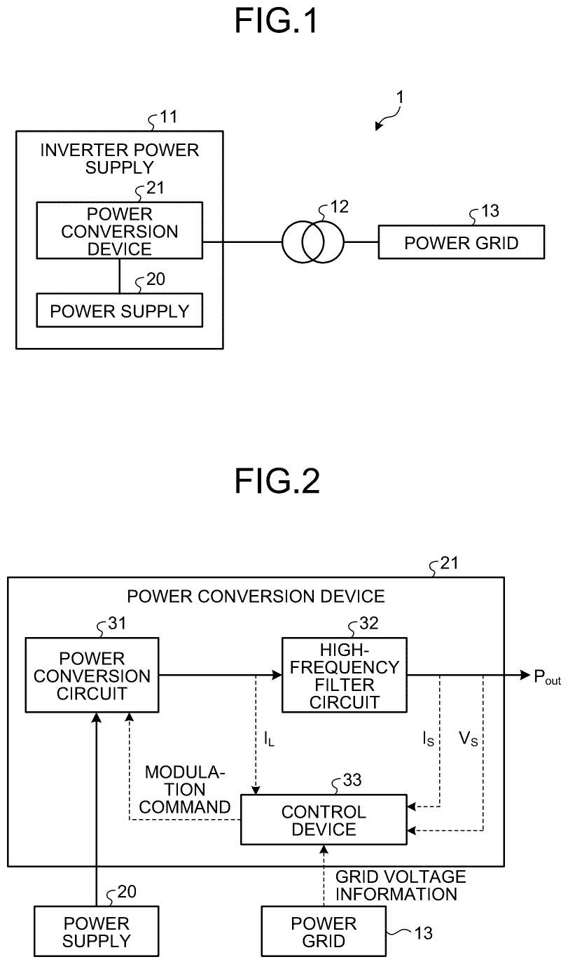

FIG. 1 is a block diagram of an example of a configuration of a power system 1 of the embodiment. The power system 1 includes an inverter power supply 11, a transformer 12, and a power grid 13. The power system 1 can be, for example, a so-called microgrid system that constitutes the self-contained power grid 13 utilizing a distributed power supply including power supplies such as the inverter power supply 11.

The inverter power supply 11 includes a power supply 20 and a power conversion device 21. The power supply 20 is a unit for outputting DC power and can be, for example, a generator utilizing renewable energy (for example, sunlight, wind power, or the like), a storage battery, or the like. The power conversion device 21 is a device converting the DC power output from the power supply 20 into AC power and outputting the AC power. Note that a plurality of power supplies 20 may be connected to one power conversion device 21.

The power conversion device 21 of the present embodiment includes a function of executing, in a switchable manner as appropriate, grid forming control (GFM control) for maintaining an amplitude and a phase of an output voltage at given set values, and grid following control (GFL control) for causing the amplitude and the phase of the output voltage to follow an amplitude and a phase of a voltage of the power grid 13.

The AC power output from the inverter power supply 11 (the power conversion device 21) is boosted by the transformer 12, and is then output to the power grid 13. Note that the transformer 12 may be unnecessary depending on the characteristics of the inverter power supply 11 and the power grid 13.

FIG. 2 is a block diagram of an example of a hardware configuration of the power conversion device 21 of the embodiment. The exemplified power conversion device 21 includes a power conversion circuit 31, a high-frequency filter circuit 32, and a control device 33 (an example of an information processing apparatus).

The power conversion circuit 31 is a circuit that converts the DC power output from the power supply 20 into the AC power. The power conversion circuit 31 can be constituted by utilizing, for example, a converter circuit, a pulse width modulation (PWM) circuit, or the like. The high-frequency filter circuit 32 is a circuit (for example, a reactor) that performs high-frequency filter (low-pass) processing on the output of the power conversion circuit 31. The control device 33 is an integrated circuit including a central processing unit (CPU), a memory, and the like. The control device 33 executes computing processing and control processing in accordance with a computer program stored in the memory. The control device 33 may be configured utilizing an application specific integrated circuit (ASIC), a field programmable gate array (FPGA), or the like.

The power conversion circuit 31 changes the amplitude and the phase of the output voltage on the basis of a modulation command output from the control device 33. The control device 33 performs the GFM control or the GFL control on the basis of a feedback signal of the output from the power conversion circuit 31, grid voltage information on the voltage of the power grid 13, and the like, to generate a modulation command to change the amplitude and the phase of output power Pout (an output voltage V_{S}) from the power conversion device 21. In the configuration exemplified herein, the control device 33 calculates active power and reactive power on the basis of a reactor current I_{L} flowing through the high-frequency filter circuit 32, an output current I_{S} from the high-frequency filter circuit 32, the output voltage V_{S} from the high-frequency filter circuit 32, etc.

The control device 33 of the present embodiment has a function of switching between the GFM control and the GFL control in accordance with a given condition, a function of correcting the modulation command in order to improve stability at the time of switching from the GFM control to the GFL control (for example, a reduction in sudden fluctuations in the output voltage or the like), etc.

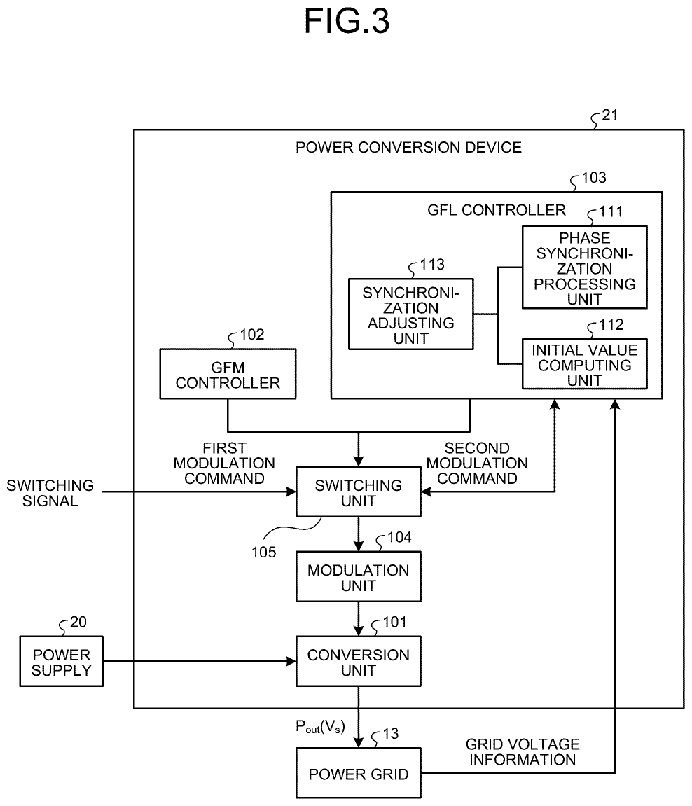

FIG. 3 is a block diagram of an example of a functional configuration of the power conversion device 21 of the embodiment. The power conversion device 21 of the present embodiment includes a conversion unit 101, a GFM controller 102 (a grid forming control unit), a GFL controller 103 (a grid following control unit), a modulation unit 104, and a switching unit 105. These functional elements 101 to 105 can be configured by, for example, cooperation of hardware elements exemplified in FIG. 2 and software elements such as a computer program controlling the control device 33.

The conversion unit 101 outputs the output power (active output power) Pout obtained by converting the DC power output from the power supply 20 into the AC power. In this process, the amplitude and the phase of the output voltage V_{S} from the conversion unit 101 are adjusted by the modulation unit 104.

The GFM controller 102 executes the GFM control for maintaining the amplitude and the phase of the output voltage V_{S} at given set values to generate a first modulation command to change the amplitude and the phase of the output voltage V_{S} by the GFM control. The GFL controller 103 executes the GFL control for causing the amplitude and the phase of the output voltage V_{S} to follow an amplitude and a phase of a voltage (a grid voltage) of a predetermined power grid (for example, the power grid 13) to generate a second modulation command to change the amplitude and the phase of the output voltage V_{S} by the GFL control.

The switching unit 105 switches input to the modulation unit 104 such that either the first modulation command or the second modulation command is input to the modulation unit 104 in accordance with a switching signal output from a given control mechanism. The modulation unit 104 changes the amplitude and the phase of the output voltage V_{S} on the basis of the first modulation command or the second modulation command.

The GFL controller 103 of the present embodiment includes a phase synchronization processing unit 111, an initial value computing unit 112, and a synchronization adjusting unit 113.

Upon reception of the switching signal instructing switching from the GFM control to the GFL control, the phase synchronization processing unit 111 computes a synchronous phase by phase synchronization processing for which the amplitude of the grid voltage is used as input.

The initial value computing unit 112 computes an initial amplitude command value based on the amplitude of the grid voltage and the synchronous phase computed by the phase synchronization processing unit 111.

The synchronization adjusting unit 113 sets the initial amplitude command value computed by the initial value computing unit 112 to be an initial value of a command value of the amplitude of the output voltage V_{S} in the GFL control after switching from the GFM control.

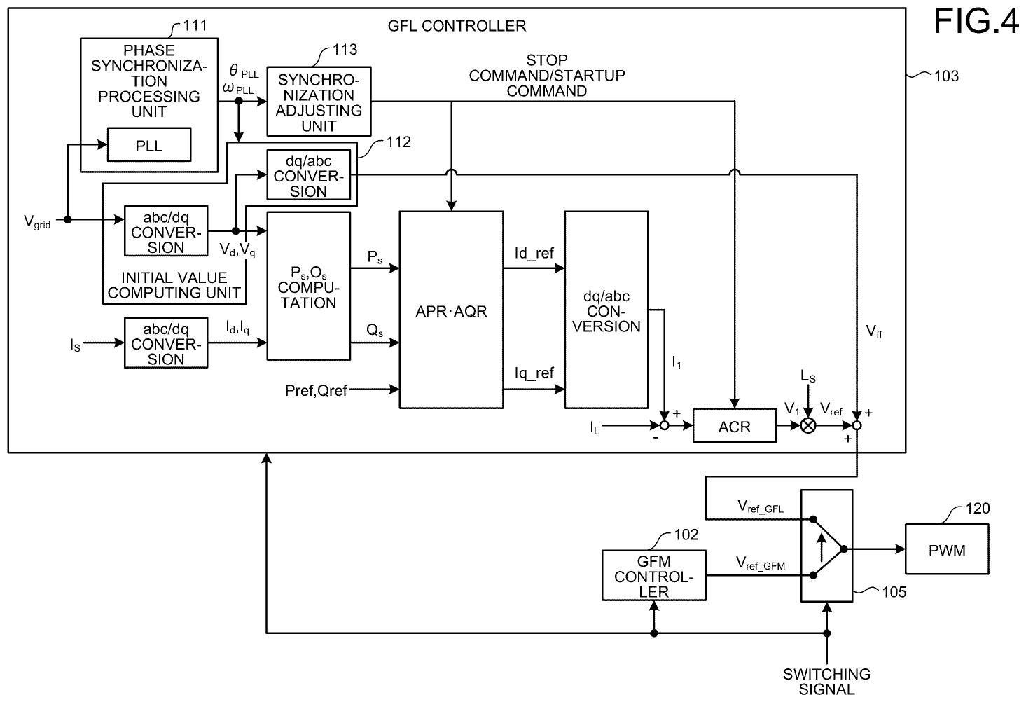

FIG. 4 is a control block diagram of a first example of processing in the GFL controller 103 of the embodiment. In the GFL controller 103, an active voltage V_{d} and a reactive voltage V_{q} are computed by dq conversion processing (abc/dq conversion) on a three-phase grid amplitude V_{grid}, and an active current I_{d} and a reactive current I_{q} are computed by dq conversion processing on the three-phase output current I_{S} (refer to FIG. 2). Active power P_{S} and reactive power Q_{S} are computed based on the active voltage V_{d} and the active current I_{d} and the reactive voltage V_{q} and the reactive current I_{q}. By performing constant power control processing (APR/AQR) with an active power command value P_{ref} and a reactive power command value Q_{ref} as target values on the active power P_{S} and the reactive power Q_{S}, respectively, an active current command value I_{d_ref} and a reactive current command value I_{q_ref} are computed. Constant current control processing (ACR) is performed on a value obtained by subtracting the reactor current I_{L} (refer to FIG. 2) from a current value I₁ computed by three-phase conversion processing (dq/abc conversion) on the active current command value I_{d_ref} and the reactive current command value I_{q_ref}. A multiplied value of a voltage value V₁ computed by the constant current control processing and a reactance L_{S} of the high-frequency filter circuit 32 is an amplitude command value V_{ref}.

In the phase synchronization processing unit 111, a synchronous phase θ_{PLL} synchronized with a grid phase and a synchronous frequency ω_{PLL} synchronized with a grid frequency are computed by phase synchronization processing (PLL) for which the grid amplitude V_{grid} is used as input. After completion of the phase synchronization processing, in the initial value computing unit 112, by performing three-phase conversion processing using the synchronous phase θ_{PLL} on the active voltage V_{d} and the reactive voltage V_{q} computed by the dq conversion processing on the grid amplitude V_{grid}, a feedforward amplitude command value V as the initial amplitude command value is computed. Note that determination on whether the phase synchronization processing is completed can be performed by using an appropriate method. For example, when a state where a difference between the synchronous frequency @PLL computed by the phase synchronization processing unit 111 and a reference frequency (50 Hz or 60 Hz) of a grid to be connected (for example, the power grid 13) is maintained not more than a threshold has continued for a given time, the determination may be made such that the phase synchronization processing is completed.

The synchronization adjusting unit 113 stops amplitude command generation processing (APR/AQR and ACR in the present embodiment) that is for generating the command value of the amplitude of the output voltage V_{S} in the GFL control (outputs a stop command to APR/AQR and ACR) when the GFM control is being executed. By stopping the amplitude command generation processing, the amplitude command value V_{ref} becomes 0, and a final amplitude command value V_{ref_GFL} output from the GFL controller 103 becomes the feedforward amplitude command value V_{ff}.

As described above, after becoming V_{ref_GFL}=V_{ff}, the switching unit 105 switches input to a PWM 120 modulating the output voltage V_{S} from an amplitude command value V_{ref_GFM} of the GFM controller 102 to the amplitude command value V_{ref_GFL} of the GFL controller 103. Subsequently, the synchronization adjusting unit 113 starts up the amplitude command generation processing (outputs a startup command to APR/AQR and ACR). Thus, at the time immediately after switching from the GFM control to the GFL control, the GFL control starts with the feedforward amplitude command value V_{ff}, which is a value close to the grid amplitude V_{grid} and the grid phase, as a target value, and then gradually shifts to the normal GFL control. This enables smooth switching from the GFM control to the GFL control without suspending the operation of the power conversion device 21.

The synchronization adjusting unit 113 of the present embodiment sets the active power and the reactive power computed in the GFM control before switching to the GFL control as the initial values of the active power command value P_{ref} and the reactive power command value Q_{ref}, respectively, to be used in the constant power control processing (APR/AQR) at the time of starting of the GFL control. This enables a stable start of the GFL control after switching.

In FIG. 4, a case where the constant current control processing (ACR) is performed on the three-phase axis as an example of the amplitude command generation processing during a normal state is exemplified, whereas the amplitude command generation processing is not limited to this example and can be executed using any appropriate method. For example, the amplitude command generation processing may perform the constant current control processing on the dq axis.

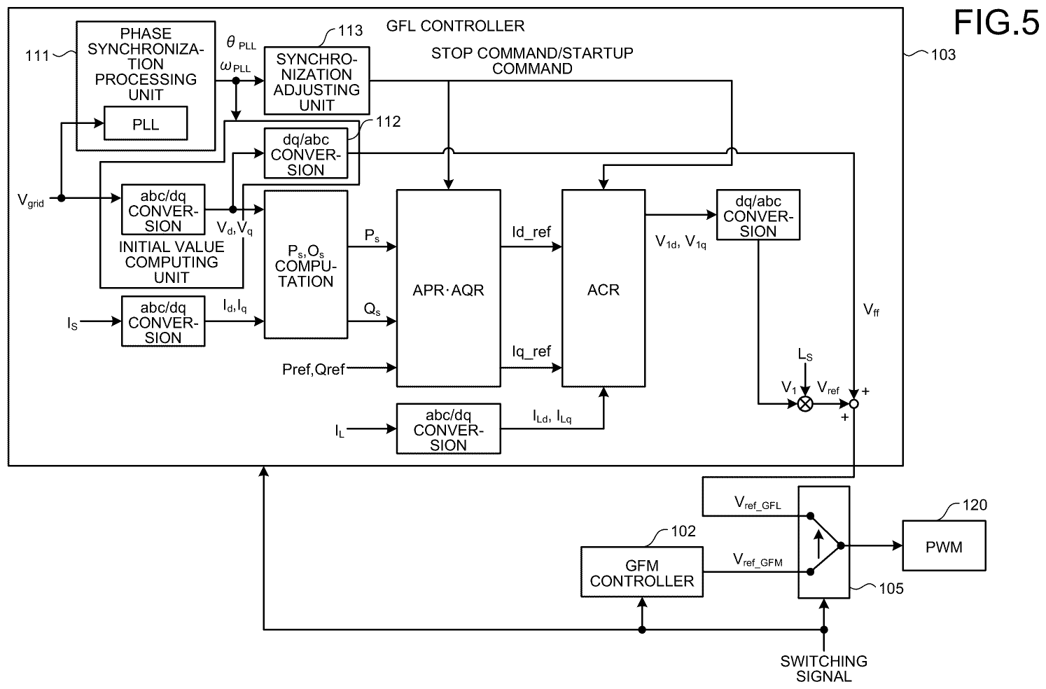

FIG. 5 is a control block diagram of a second example of the processing in the GFL controller 103 of the embodiment. In FIG. 5, the amplitude command generation processing in a case where the constant current control processing is performed on the dq axis is exemplified. In this case, an active reactor current value I_{Ld} and a reactive reactor current value I_{Lq} are calculated by the dq conversion processing (the abc/dq conversion) on the reactor current I_{L}. An active voltage Vid and a reactive voltage V_{1q} are calculated by the constant current control processing (ACR) based on the active reactor current value I_{Ld} and the reactive reactor current value I_{Lq} and the active current command value I_{d_ref} and the reactive current command value I_{q_ref}. A multiplied value of the voltage value V₁ calculated by the three-phase conversion processing (the dq/abc conversion) on the active voltage Vid and the reactive voltage V_{1q} and the reactance L_{S} is the amplitude command value V_{ref}.

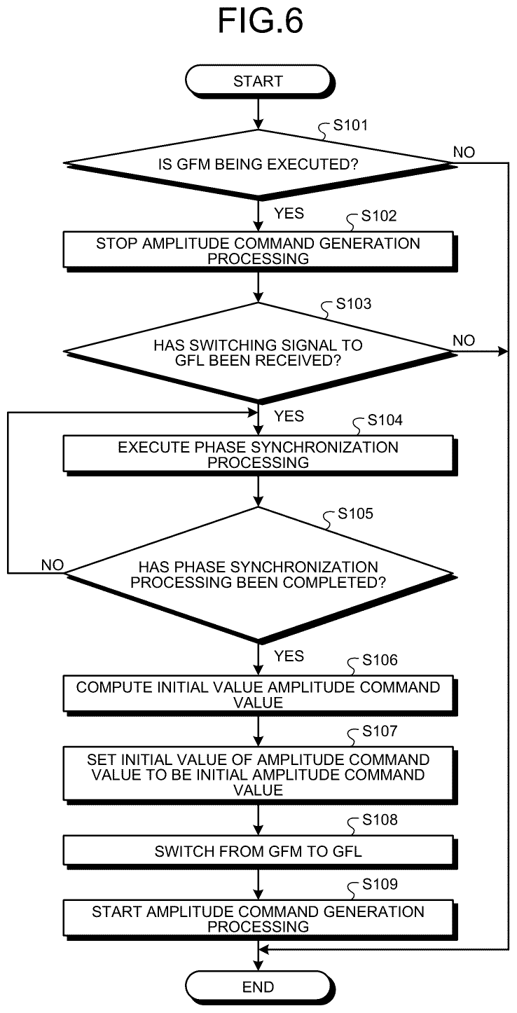

FIG. 6 is a flowchart of an example of processing at the time of switching from the GFM control to the GFL control by the power conversion device 21 of the embodiment. The phase synchronization processing unit 111 determines whether the GFM control is being executed (whether the first modulation command has been input to the modulation unit 104) (S101), and, if the GFM control is not being executed (No at S101), ends the present routine. If the GFM control is being executed (Yes at S101), the synchronization adjusting unit 113 stops the amplitude command generation processing (APR/AQR and ACR) during a normal state in the GFL control (S102), and the phase synchronization processing unit 111 determines whether the switching signal switching to the GFL control has been received (S103). If the switching signal to the GFL control has not been received (No at S103), the present routine ends.

If the switching signal to the GFL control has been received (Yes at S103), the phase synchronization processing unit 111 executes the phase synchronization processing for which the grid amplitude V_{grid} is used as input (S104), and computes the synchronous phase θ_{PLL}. Subsequently, the phase synchronization processing unit 111 determines whether the phase synchronization processing has been completed (S105), and, if the phase synchronization processing has not been completed (No at S105), the phase synchronization processing is continued (S104). If the phase synchronization processing has been completed (Yes at S105), the initial value computing unit 112 computes the initial amplitude command value (the feedforward amplitude command value V_{ff}) based on the grid amplitude V_{grid} and the synchronous phase θ_{PLL} (S106). With this processing, the initial value of the amplitude command value V_{ref_GFL} of the GFL control is set to be the initial amplitude command value (the feedforward amplitude command value V_{ff}) (S107). After that, the switching unit 105 switches input to the modulation unit 104 (the PWM 120) from the amplitude command value V_{ref_GFM} of the GFM control to the amplitude command value V_{ref_GFL} of the GFL control (S108), and the synchronization adjusting unit 113 starts up the amplitude command generation processing (S109).

According to the above-described embodiment, when the GFM control switches to the GFL control, the GFL control is started up with the feedforward amplitude command value V_{ff}, which is close to the grid amplitude V_{grid} and the grid phase θ_{grid}, as the initial value of the command value. Therefore, it is possible to reduce fluctuations in the output voltage at the time of switching and possible to stably perform switching from the GFM control to the GFL control without suspending the power conversion device 21.

A computer program for implementing the function of the power conversion device 21 of the embodiment described above is provided and embedded in advance mainly in a storage device included in the power conversion device 21, but this is not limiting. The computer program may be recorded and provided in a computer-readable recording medium such as a compact disc read only memory (CD-ROM), a flexible disk (FD), a compact disc recordable (CD-R), and a digital versatile disc (DVD), as an installable or executable file. The storage medium is not limited to a medium independent of a computer or incorporated system and also includes a storage medium in which a computer program transmitted via a local area network (LAN), the Internet, or the like is downloaded and stored or temporarily stored.

The computer program may be stored in a computer connected to a network such as the Internet and provided by being downloaded via the network or provided or distributed via a network such as the Internet.

The above has described some embodiments of the present invention. These embodiments have been presented by way of example and do not intend to limit the scope of the invention. These novel embodiments can be performed in other various ways, and various omissions, replacements, and modifications can be made without departing from the gist of the invention. These embodiments and modifications thereof are included in the scope and the gist of the invention and are also included in the inventions described in the claims and the scope of equivalence thereof.

### REFERENCE SIGNS LIST

1: power system, 11: inverter power supply, 12: transformer, 13: power grid, 20: power supply, 21: power conversion device, 31: power conversion circuit, 32: high-frequency filter circuit, 33: control device, 101: conversion unit, 102: GFM controller, 103: GFL controller, 104: modulation unit, 105: switching unit, 111: phase synchronization processing unit, 112: initial value computing unit, 113: synchronization adjusting unit, 120: PWM

1. A power conversion device comprising:
a conversion circuit configured to convert DC power output from a power supply into AC power and output the AC power;
a grid forming control circuit configured to generate a first modulation command to change an amplitude and a phase of an output voltage from the conversion circuit by grid forming control for maintaining the amplitude and the phase of the output voltage at given set values;
a grid following control circuit configured to generate a second modulation command to change the amplitude and the phase of the output voltage by grid following control for causing the amplitude and the phase of the output voltage to follow an amplitude and a phase of a grid voltage as a voltage of a given power grid;
a modulation circuit configured to change the amplitude and the phase of the output voltage on the basis of the first modulation command or the second modulation command;
a switching circuit configured to switch, in accordance with a switching signal, input to the modulation circuit such that either the first modulation command or the second modulation command is input to the modulation circuit;
a phase synchronization processing circuit configured to compute a synchronous phase by phase synchronization processing for which the amplitude of the grid voltage is used as input, the synchronous phase being computed when the switching signal instructing switching from the grid forming control to the grid following control is received;
an initial value computing circuit configured to compute an initial amplitude command value based on the amplitude of the grid voltage and the synchronous phase; and
a synchronization adjusting circuit configured to set the initial amplitude command value to be an initial value of a command value of the amplitude of the output voltage in the grid following control after switching from the grid forming control.

2. The power conversion device according to claim 1, wherein the synchronization adjusting circuit is configured to
stop, when the grid forming control is being executed, amplitude command generation processing for generating the command value of the amplitude of the output voltage in the grid following control, and
start up the amplitude command generation processing after switching to the grid following control.

3. The power conversion device according to claim 1, wherein
the grid following control includes constant power control processing for changing an active current and a reactive current such that active power and reactive power match an active power command value and a reactive power command value, respectively, and
the synchronization adjusting circuit is configured to set active power and reactive power computed in the grid forming control before switching to the grid following control to be an initial value of the active power command value and an initial value of the reactive power command value, respectively, in the constant power control processing of the grid following control after switching.

4. A non-transitory computer-readable recording medium on which programmed instructions are recorded, the instructions causing a computer to execute processing, the computer including a conversion circuit serving to convert DC power output from a power supply into AC power and output the AC power, the processing to be executed by the computer comprising:
processing of generating a first modulation command to change an amplitude and a phase of an output voltage from the conversion circuit by grid forming control for maintaining the amplitude and the phase of the output voltage at given set values;
processing of generating a second modulation command to change the amplitude and the phase of the output voltage by grid following control for causing the amplitude and the phase of the output voltage to follow an amplitude and a phase of a grid voltage as a voltage of a given power grid;
processing of changing the amplitude and the phase of the output voltage on the basis of the first modulation command or the second modulation command;
processing of switching, in accordance with a switching signal, input to the modulation circuit such that either the first modulation command or the second modulation command is input to the modulation circuit;
processing of computing a synchronous phase by phase synchronization processing for which the amplitude of the grid voltage is used as input, the synchronous phase being computed when the switching signal instructing switching from the grid forming control to the grid following control is received;
processing of computing an initial amplitude command value based on the amplitude of the grid voltage and the synchronous phase; and
adjustment processing of setting the initial amplitude command value to be an initial value of a command value of the amplitude of the output voltage in the grid following control after switching from the grid forming control.

5. The recording medium according to claim 4, wherein the adjustment processing includes processing of
stopping, when the grid forming control is being executed, amplitude command generation processing for generating the command value of the amplitude of the output voltage in the grid following control, and
starting up the amplitude command generation processing after switching to the grid following control.

6. The recording medium according to claim 4, wherein
the grid following control includes constant power control processing for changing an active current and a reactive current such that active power and reactive power match an active power command value and a reactive power command value, respectively, and
the adjustment processing includes processing of setting active power and reactive power computed in the grid forming control before switching to the grid following control to be an initial value of the active power command value and an initial value of the reactive power command value, respectively, in the constant power control processing of the grid following control after switching.

7. A control method implemented by a device including a conversion circuit, a grid forming control circuit, a grid following control circuit, a modulation circuit, and a switching circuit, the conversion circuit serving to convert DC power output from a power supply into AC power and output the AC power, the grid forming control circuit serving to generate a first modulation command to change an amplitude and a phase of an output voltage from the conversion circuit by grid forming control for maintaining the amplitude and the phase of the output voltage at given set values, the grid following control circuit serving to generate a second modulation command to change the amplitude and the phase of the output voltage by grid following control for causing the amplitude and the phase of the output voltage to follow an amplitude and a phase of a grid voltage as a voltage of a given power grid, the modulation circuit serving to change the amplitude and the phase of the output voltage on the basis of the first modulation command or the second modulation command, the switching circuit serving to switch, in accordance with a switching signal, input to the modulation circuit such that either the first modulation command or the second modulation command is input to the modulation circuit, the control method comprising:
computing a synchronous phase by phase synchronization processing for which the amplitude of the grid voltage is used as input, the synchronous phase being computed when the switching signal instructing switching from the grid forming control to the grid following control is received;
computing an initial amplitude command value based on the amplitude of the grid voltage and the synchronous phase; and
performing adjustment processing including setting the initial amplitude command value to be an initial value of a command value of the amplitude of the output voltage in the grid following control after switching from the grid forming control.

8. The control method according to claim 7, wherein the performing adjustment processing includes
stopping, when the grid forming control is being executed, amplitude command generation processing for generating the command value of the amplitude of the output voltage in the grid following control, and
starting up the amplitude command generation processing after switching to the grid following control.

9. The control method according to claim 7, wherein
the grid following control includes constant power control processing for changing an active current and a reactive current such that active power and reactive power match an active power command value and a reactive power command value, respectively, and
the performing adjustment processing includes setting active power and reactive power computed in the grid forming control before switching to the grid following control to be an initial value of the active power command value and an initial value of the reactive power command value, respectively, in the constant power control processing of the grid following control after switching.
